(19) United States
(12) Patent Application Publication
(10) Pub. No.: US 2009/0125266 A1
(43) Pub. Date: May 14, 2009

(54) APPARATUS FOR GENERATING VEHICLE SPEED SIGNAL AND METHOD THEREOF

(76) Inventor: Hoyoung Lee, Incheon (KR)

Correspondence Address: MORGAN, LEWIS & BOCKIUS LLP (SF), One Market, Spear Street Tower, Suite 2800, San Francisco, CA, 94105, US

(21) Appl. No.: 11/966,575

(22) Filed: Dec. 28, 2007

(30) Foreign Application Priority Data
Nov. 13, 2007 (KR) 10-2007-0115532

(51) Int. Cl. G06F 19/00

(52) U.S. Cl. 702/96

(57) ABSTRACT

Disclosed is an apparatus for generating a vehicle speed signal that can minimize the number of arithmetic operations of an electronic control device. The apparatus includes a PG-B (Pulse Generator B) sensor that is mounted to an output shaft of an automatic transmission, and outputs pulses according to the rotation of the transmission output shaft, a counter that counts pulses from the PG-B sensor and of the predetermined number of pulses are counted, outputs a pulse counter (PC), a vehicle speed signal generation unit that generates a vehicle speed signal in synchronization with the pulse counter (PC) from the counter, an error correction unit that corrects an error in the vehicle speed signal having decimal places from the vehicle speed signal generation unit and defines the vehicle speed signal by an integer ratio, and a speedometer that visualizes and displays the error-corrected vehicle speed signal as a current vehicle speed.

### CROSS-REFERENCE TO RELATED APPLICATION

This application claims priority to and the benefit of Korean Patent Application No. 10)-2007-0115532, filed in the Korean Intellectual Property Office on Nov. 13, 2007, the entire contents of which are incorporated herein by reference.

### BACKGROUND OF THE INVENTION

(a) Field of the Invention

The present invention relates to an apparatus for generating, a vehicle speed signal and a method thereof, and in particular, an apparatus for generating a vehicle speed signal and a method thereof that can minimize the number of arithmetic operations of an electronic control unit.

(b) Description of the Related Art

In general, a vehicle speed is directly detected by a vehicle speed sensor that is mounted to an output shaft of a vehicle. The vehicle speed sensor generates pulses according to the rotation of the vehicle output shaft and displays the vehicle speed through a speedometer in a cluster.

However, in recent years, to cut costs, the vehicle speed sensor is not installed in the vehicle. Accordingly, in an indirect manner to detect the vehicle speed, a vehicle speed signal is calculated and output by an electronic control unit, such as an ABS (Anti-lock Brake System), an ECU (Engine Control Unit), or a TCU.

A vehicle, on which an automatic transmission is mounted, automatically shifts the gear position to a target gear position according to a current driving condition. For gear shift control, the opening of a throttle valve, which is opened/closed according to the operation of an accelerator pedal, and vehicle speed information are required.

Accordingly, the TCU is mounted to the output shaft of the transmission and calculates the vehicle speed by applying dimensional data of the vehicle, such as a tire dynamic radius and a final reduction gear ratio, to a signal from a PG-B (Pulse Generator B) sensor, generates pulses according to the rotation of the transmission output shaft.

First, an output shaft rotation speed is calculated as follows using the signal from the PG-B sensor.

$$Output Shaft rotation Speed = \frac{PG \text{-} B Pulse}{Number of Teeth on Target Wheel}$$

Subsequently, an actual vehicle speed is calculated as follows by applying the dimensional data of the vehicle, such as the tire dynamic radius and the final reduction gear ratio, to the calculated output shaft rotation speed.

$$Vehicle Speed [ Vr ( KPH ) ] = \frac{Output Shaft rotation Speed}{Final Reduction Gear Ratio} * Tire Dynamic Radius * \frac{2 π * 60}{1000}$$

Then, a reference vehicle speed pulse, which defines 2548 pulses at 60 Km/h, is applied to the calculated vehicle speed so as to determine a vehicle speed signal, which is displayed though the speedometer of the cluster.

Vehicle Speed Pulses=Vehicle Speed (Km/h)/60×2584

In this way, the TCU calculates the output shalt speed for every predetermined calculation cycle for example, 10 ms, then calculates the vehicle speed from the output shaft speed, and subsequently calculates the vehicle speed pulses. The calculated vehicle speed pulses are transmitted to the cluster so as to display a current vehicle speed through the speedometer.

The above-described vehicle speed calculation method is considerably accurate. In this case, however, since the TCU needs to repeatedly perform a complex vehicle speed calculation loop for every predetermined calculation cycle, for example, 10 ms, a large load is imposed on the TCU.

In addition, each time a logic, which requires a large number of arithmetic operations, such as fuzzy control, operates in the TCU and thus the TCU suffers from an overload of calculation. To prevent this problem, a high-performance processor needs to be provided, which causes an increase in costs.

The above information disclosed in this Background section is only for enhancement of understanding of the background of the invention and therefore it may contain information that does not form the prior art that is already known in this country to a person ordinary skill in the art.

### SUMMARY OF THE INVENTION

The present invention has been made in an effort to provide an apparatus for generating a vehicle speed signal and a method thereof, having advantages of minimizing the number of arithmetic operations of a TCU by counting pulses from a PG-B sensor and if a predetermined number of pulses are counted, generating a pulse counter (Pulse Counter: PC) so as to generate a vehicle speed signal.

An exemplary embodiment of the present invention provides an apparatus for generating a vehicle speed signal. The apparatus includes a PG-B (Pulse Generator B) sensor that is mounted to an output shaft of an automatic transmission, and outputs pulses according to the rotation of the transmission output shaft; a counter that counts pulses from the PG-B sensor and if a predetermined number of pulses are counted, outputs a pulse counter (PC); a vehicle speed signal generation unit that generates a vehicle speed signal in synchronization with the pulse counter (PC) from the counter; an error correction unit that corrects an error in the vehicle speed signal having decimal places from the vehicle speed signal generation unit and defines the vehicle speed signal by an integer ratio; and a speedometer that visualizes and displays the error-corrected vehicle speed signal as a current vehicle speed.

Another embodiment of the present invention provides a method of generating a vehicle speed signal. The method includes: detecting and counting pulses from a PG-B sensor when driving starts; if a predetermined number of pulses from the PG-B sensor is counted, outputting a trigger signal, and generating and outputting a vehicle speed signal in synchronization with the trigger signal; correcting a decimal error in the vehicle speed signal by an integer ratio by adding “1” to an integer of the pulse counter according to a range of decimal values; and displaying the corrected vehicle speed signal through a speedometer.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing the schematic configuration of an apparatus for generating a vehicle speed signal according to an exemplary embodiment of the present invention,

FIG. 2 is a flowchart illustrating a procedure of generating a vehicle speed signal according to an exemplary embodiment of the present invention,

FIG. 3 is a timing chart showing a case where a vehicle speed signal is generated according to an exemplary embodiment of the present invention.

### DESCRIPTION OF REFERENCE NUMERALS INDICATING PRIMARY ELEMENTS IN THE DRAWINGS

10: PG-B sensor
20: counter
30: vehicle speed signal generation unit
40: error correction unit
50: speedometer

It should be understood that the appended drawings are not necessarily to scale, presenting a somewhat simplified representation of various preferred features illustrative of the basic principles of the invention. The specific design features of the present invention as disclosed herein including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims

In the following detailed description, only certain exemplary embodiments of the present invention have been shown and described, simply by way of illustration.

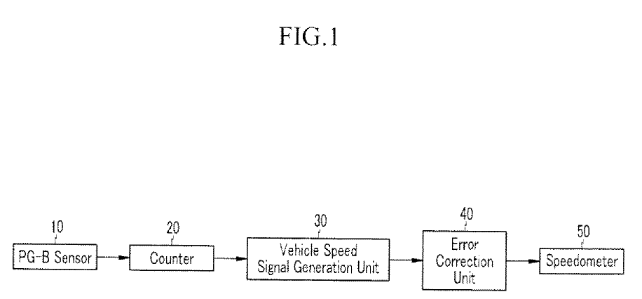

FIG. 1 is a diagram showing the schematic configuration of an apparatus for generating a vehicle speed signal (hereinafter, referred to as “vehicle speed signal generating apparatus”) according to an exemplary embodiment of the present invention.

As shown in FIG. 1, a vehicle speed signal generating apparatus according to the embodiment of the present invention includes a PG-B sensor 10, a counter 20, a vehicle speed signal generation unit 30, an error correction unit 40, and a speedometer 50.

The PG-B sensor 10 is mounted to an output shalt of an automatic transmission, and generates pulses according to the rotation of the transmission output shaft.

The counter 20 counts the pulses from the PG-B sensor 10 and if a predetermined number of pulses are counted, outputs a pulse counter PC.

The pulse counter PC is determined by a pulse ratio between the output pulses of the PG-B sensor and the reference vehicle speed pulses.

$$P C ( Pulse Counter ) = \frac{PG \text{-} B Pulses}{Reference Vehicle Speed Pulses}$$

Here, in calculating the pulse counter PC, it is assumed that the number of reference vehicle speed pulses is 2548 at the vehicle speed of 60 Km/h in an exemplary embodiment of the present invention.

The vehicle speed signal generation unit 30 generates a vehicle speed signal of the current vehicle speed in synchronization with the pulse counter PC from the counter 20.

However, the pulse counter PC includes values of not only integer but also decimal digit, which may result in error in estimating the vehicle speed signal. In order to overcome this problem, the error correction unit 40 is used as explained next.

The error correction unit 40 corrects an error in the calculated vehicle speed signal by adding “1” to the integer of the pulse counter PC according to a range of decimal values of pulse counter PC so as to define the vehicle speed signal having decimal places from the vehicle speed signal generation unit 30 by an integer ratio.

The speedometer 50 visualizes and displays the error-corrected vehicle speed signal as current vehicle speed information.

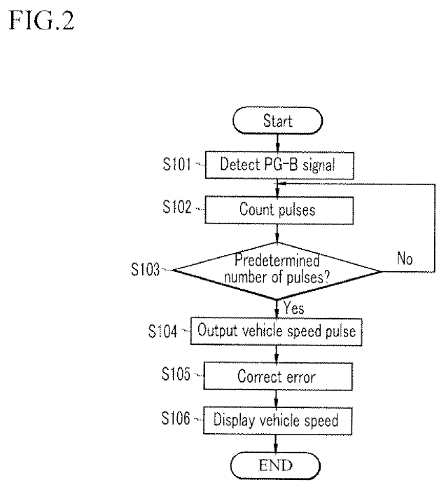

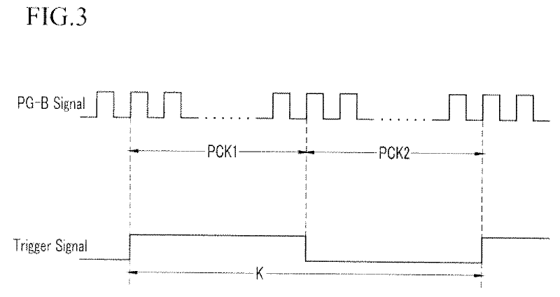

According to an exemplary embodiment of the present invention, the operation of the vehicle speed signal generating apparatus having the above-described functions will be described with reference to FIGS. 2 and 3 in detail.

If the vehicle, on which an automatic transmission is mounted, starts driving, the PG-B sensor 10 generates the pulses according to the rotation of the output shaft and transmits the generated pulses to the counter 20 (Step S101).

The counter 20 counts the transmitted pulses (Step S102) and whenever a predetermined number of vehicle speed pulses are counted, the counter 20 outputs the pulse counter PC to the vehicle speed signal generation unit 30 (Step S103).

The pulse counter PC signifying the pulse ratio between the pulses from the PG-B sensor 10 and the reference vehicle speed pulses is shown in FIG. 3.

That is, when the predetermined number of vehicle speed pulses transmitted from the PG-B sensor 10 is counted, value of pulse counter PCK1 is output. Subsequently, if one more predetermined number of vehicle speed pulses are counted again, another value of pulse counter PCK2 is output. The two pulse counters PCK1 and PCK2 are output as a single vehicle speed signal K.

The vehicle speed signal generation unit 30 generates the calculated vehicle speed signal K in synchronization with the pulse counter PC.

However, since the pulse counter PC may include a decimal value, the decimal value must also be considered to estimate an exact vehicle speed signal K.

According, after the vehicle speed signal generation unit 30 transmits the generated vehicle speed signal K to the error correction unit 40 (Step S104), the error correction unit 40 corrects the error in the vehicle speed signal K by adding “1” the integer of the pulse counter PC according to the range of decimal values so as to define the vehicle speed signal K having decimal places by an integer ratio (Step S105).

That is, the threshold value of the vehicle speed signal is calculated and corrected on the basis of the K=2×[PC (integer)+A (decimal)].

When the vehicle speed signal of the current vehicle speed is output on the basis of the vehicle speed signal K, the pulse counter PC and the correction value (PC+1) of the pulse counter are appropriately used to correct the value A (decimal), as shown in Table 1.

TABLE 1

| | Use of Threshold Value of Vehicle | |
|---|---|---|
| A(Decimal) Range | Speed Signal and Correction Value | Error Range |
| 0 ≦ A < 0.1 | PC 1 | 0.0 ≦ e < 0.1 |
| 0.1 ≦ A < 0.2 | PC 9, (PC + 1) 1 | 0.0 ≦ e < 0.1 |
| 0.2 ≦ A < 0.3 | PC 8, (PC + 1) 2 | 0.0 ≦ e < 0.1 |
| 0.3 ≦ A < 0.4 | PC 7, (PC + 1) 3 | 0.0 ≦ e < 0.1 |
| 0.4 ≦ A < 0.5 | PC 6, (PC + 1) 4 | 0.0 ≦ e < 0.1 |
| 0.5 ≦ A < 0.6 | PC 5, (PC + 1) 5 | 0.0 ≦ e < 0.1 |
| 0.6 ≦ A < 0.7 | PC 4, (PC + 1) 6 | 0.0 ≦ e < 0.1 |
| 0.7 ≦ A < 0.8 | PC 3, (PC + 1) 7 | 0.0 ≦ e < 0.1 |
| 0.8 ≦ A < 0.9 | PC 2, (PC + 1) 8 | 0.0 ≦ e < 0.1 |
| 0.9 ≦ A < 1.0 | PC 1, (PC + 1) 9 | 0.0 ≦ e < 0.1 |

For example, it is assumed that the pulse counter PC is calculated on the basis of the pulse ratio between the PG-G pulses and the predetermined number of reference vehicle speed pulses. Then, the correction of error is followed. From Table 1, if the calculated pulse counter PC is 27.4, the vehicle speed signal K can be assumed to be triggered ten times.

To generate 10 triggers in the vehicle speed signal K, 274 PG-B pulses are required.

If the pulse counter PC is 27, the number of PG-B pulses is 270 when 10 triggers are generated, and accordingly 4 errors occur. However, from the above table, if the correction value PC+1 of 28 is applied four times and PC of 27 is applied six times, the total number of PG-B pulses becomes 274 and as a result, no error occurs.

Meanwhile, the pulse counter PC may, not having a single decimal place, have two or more decimal places, for example, 27.453. At this time, a rounding error may occur, but the error range is 0.0≦e<0.1.

If the above-described method is applied, it is not necessary for the TCU to calculate the actual speed for every 10 ms. That is, the pulses from the PG-B sensor 10 are counted, and then the vehicle speed signal is immediately generated according to the pulse counter PC. In addition, the error range is less than 0.1% with the correction logic, thereby stably and rapidly generating the vehicle speed signal.

The generated vehicle speed signal is transmitted to the speedometer 50 in the cluster, and then a current vehicle speed is displayed by an analog indicator or a digital numerical value (Step S106).

According, to the embodiment of the present invention, the load of the electronic control unit, which generates the vehicle speed signal, can be reduced, thereby increasing the efficiency of the electronic control unit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for generating a vehicle speed signal, the apparatus comprising:
a PG-B (Pulse Generator B) sensor that is mounted to an output shaft of an automatic transmission and outputs pulses according to the rotation of the transmission output shaft;
a counter that counts the pulses from the PG-B sensor and if a predetermined number of pulses are counted, outputs a pulse counter (PC);
a vehicle speed signal generation unit that generates a vehicle speed signal in synchronization with the pulse counter (PC) from the counter;
an error correction unit that corrects an error in the vehicle speed signal having decimal places from the vehicle speed signal generation unit and defines the vehicle speed signal by an integer ratio; and
a speedometer that visualizes and displays the error-corrected vehicle speed signal as a current vehicle speed.

2. The apparatus of claim 1, wherein the pulse counter (PC) from the counter is determined by a pulse ratio between the output pulses of the PG-B sensor and a predetermined number of reference vehicle speed pulses.

3. The apparatus of claim 2, wherein the predetermined number of reference vehicle speed pulses is 2548 at a vehicle speed of 60 Km/h.

4. The apparatus of claim 1, wherein the error correction unit adds “1” to an integer of the pulse counter according to a range of decimal values so as to correct the error in the vehicle speed signal having decimal places.

5. A method of generating a vehicle speed signal, the method comprising:
detecting and counting pulses from a PG-B sensor when driving starts;
if a predetermined number of pulses from the PG-B sensor is counted, outputting a trigger signal, and generating and outputting vehicle speed signal in synchronization with the trigger signal;
correcting a decimal error in the vehicle speed signal by an integer ratio by adding “1” to an integer of the pulse counter according to a range of decimal values, and
displaying the corrected vehicle speed signal through a speedometer.
